(19) United States
(12) Patent Application Publication
(10) Pub. No.: US 2017/0108939 A1
(43) Pub. Date: Apr. 20, 2017

(54) METHOD AND APPARATUS FOR CONTROLLING A DEVICE BASED ON PERSONALIZED PROFILES ON A WEARABLE DEVICE

(71) Applicant: Samsung Electronics Co., Ltd., Suwon-si (KR)

(72) Inventors: Avinash Sudhakar CHILMULWAR, Bangalore (IN); Vinay SINGH, Bangalore (IN); Mayank GUPTA, Bangalore (IN)

(21) Appl. No.: 15/255,846

(22) Filed: Sep. 2, 2016

(30) Foreign Application Priority Data
Oct. 16, 2015 (IN) 1031/CHE/2015

(51) Int. Cl. G06F 3/038; G06K 9/00; G06F 3/0346; G06F 3/0362; G06F 3/01

(52) U.S. Cl. CPC G06F 3/038; G06F 3/0362; G06F 3/017; G06F 3/0346; G06K 9/00067; H04W 4/008

(57) ABSTRACT

The various example embodiments herein disclose a method and apparatus for controlling at least one device by a wearable device, the method comprising determining a position of the wearable device on a finger of a user based on a biometric parameter of the finger, activating a profile corresponding to the determined position of the wearable device on the user's finger; and controlling the at least one device based on the activated profile.

### CROSS-REFERENCE TO RELATED APPLICATION

This application claims the benefit under 35 U.S.C. §119(a) of Indian Application Number 1031/CHE/2015 filed with the Indian Patent Office on Oct. 16, 2015, the disclosure of which is incorporated herein in its entirety by reference.

### BACKGROUND

1. Field of the Invention

The present disclosure relates to a method and system for controlling the operation of nearby electronic devices using a short range wireless communication link with a wearable device, such as a smart ring.

2. Description of the Related Art

Traditional human computer interfaces require a high amount of attention for operation, reducing a user's freedom of movement and ability to perform other tasks simultaneously. The user usually sits in front of the laptop or desktop computer while looking at the screen interacts with the same via a keyboard and mouse. Other mobile devices such as PDAs and mobile phones require the user to hold them in one hand while the interaction is happening. The input mechanism in this case is typically a touch input via a finger or stylus in conjunction with a touch screen, an input via a joystick and/or a mouse, and/or an input via a number of buttons. In both cases, entering a user input may distract the user from the current task. Considering that such devices are usually transported in a pocket or bag, each time the user wishes to interact with the device, the user has to retrieve the device, use one or two of her hands in order to interact with the device, and then return the device to its original location.

Currently, the electronic device industry is presenting various ways for customers to communicate with their devices, e.g. touch sensors, proximity sensors, accelerometers, gyroscopes, etc. Day by day, various newer and smaller sensors are coming to market and being implemented in electronic wearable devices to enhance user experience.

There are many processes for authenticating a user to verify the identity of the user or whether the user is authorized to access particular resources in a stand-alone computer system or portable electronic device. Different system administrators may have different security requirements based on the business needs of the systems they administer and thus may require different types of authentication mechanisms. For example, some systems only require presenting a simple user id and password. Other systems are more sophisticated and require the user to employ authentication mechanisms such as a smart card, a token card, a fingerprint scanner or the like.

Generally, biometric authentication is potentially the most robust and convenient method of user authentication for portable and desktop/enterprise computer systems, as the user is not required to create or remember passwords or to carry a badge or a smart card. Biometric authentication processes include finger print scanning, graphical signature scanning, dynamic hand-force sensing while executing a signature, iris and retinal scanning, voice print scanning, and many other techniques. Fingerprint scanning is currently the most proven form of biometric authentication. Other biometric authentication processes in development include retina and iris scanning, hand and face geometry scanning, body odor profiling, and others. Among biometric authentication techniques, vein pattern authentication techniques are gaining attention nowadays.

Blood veins are present internally within the human body, forming a web-like connection between various parts of the body. The distribution and spreading of veins throughout the human body is unique to each and every person. The chances of two persons having similar fingerprints can be possible, but it is not possible for two persons to have a similar vein structure and vein pattern. Therefore, to provide a higher level of security and authentication, vein identification and authentication systems have been introduced.

FIG. 1 is a schematic diagram 100 illustrating a vein identification and authentication technique according to the existing art. According to the FIG. 1, the diagram 100 includes a human finger 102, veins 104, a near infrared light emitting diode (LED) source 106, and a CMOS sensor 108. According to the diagram 100, when the user places his finger 102 between CMOS sensor 108 and near infrared LED source 106, the near infrared LED source 106 emits infrared light onto the finger 102. Due to the infrared light emitted from the near infrared LED source 106, veins 104 and patterns of the veins in the finger 102 may be detectable, for example, by the CMOS sensor 108. The emitted infrared light highlights vein patterns of the finger 102, which can be received by CMOS sensor 108. The infrared light emitted by near infrared LED source 106 and received by the CMOS sensor 108 can be processed, and the vein pattern of the finger 102 of the user can be obtained.

The vein pattern of the user can be stored for identifying or authenticating the user, and whenever the user attempts to perform a particular action, part of the authentication includes verifying the vein pattern of the same finger. The newly obtained vein pattern can be matched with the stored vein pattern to authenticate the user. It is to be remembered that the same portion of the finger scanned when storing the vein pattern of the user also has to be scanned during authentication, as vein patterns change according to finger or and regions of each finger of the same user. As vein pattern identification and authentication techniques require a higher level of precision and matching, the security and matching techniques involved are efficient.

Currently, vein identification and authentication techniques are used for accessing electronic devices and applications. However, the existing devices do not use vein authentication techniques for controlling a plurality of devices and appliances remotely.

Thus, there is a need for a wearable device, for example, a smart ring, worn by a user which enables the user to control an electronic device that is connected, for example, wirelessly, to a controller housed in the wearable device.

The above mentioned shortcomings, disadvantages and problems are addressed herein and will be understood by reading and studying the following specification.

### SUMMARY OF THE INVENTION

The various example embodiments herein disclose a system and method of generating personalized user profiles based positions of a wearable device, such as a smart ring, on a finger of a user and authenticating the user by a finger vein biometric authentication technique.

According to an embodiment of the present disclosure, a method of generating personalized profiles on a wearable device to control electronic devices, the method comprising steps of detecting, by the wearable device, a position of the wearable device on a finger of a user based on a biometric parameter of a user's finger, generating, by the wearable device, a plurality of user defined profiles, each profile associated with a position of the wearable device on the user's finger, activating, by the wearable device, a profile corresponding to the detected position, and receiving a user's input on the wearable device to perform a preset action.

In an example embodiment of the present disclosure, the biometric parameter is a finger vein biometric. In an example embodiment of the present disclosure, activation and deactivation of the wearable device is performed by moving the wearable device according to a preset pattern, wherein the preset pattern comprises one of a unique pattern, a distinct pattern or a combination of different mechanical movements of the wearable device configured in each finger profile based on different positions on the finger. In another example embodiment of the present disclosure, the different mechanical movement of the wearable device is mapped to different functionalities, where the functionalities is enabled or disabled based on a user selection.

In an example embodiment of the present disclosure, the preset action comprises at least one of, but not limited to selecting and controlling one or more electronic devices controlling home automation systems, operating automobile vehicles and vehicle accessories, vital sign monitoring of the user, selecting one or more pay cards for initiating a mode of payment, sharing the user defined profiles corresponding to each position with one or more users of the wearable device, sending an alert for personal missing elements through device to device interaction, and the like. In another example embodiment of the present disclosure, the selected one or more electronic devices are displayed on a display screen on the wearable device.

According to another example embodiment of the present disclosure, a method of controlling electronic devices, comprising steps of generating, by a wearable device, a plurality of profiles, each profile associated with a position of a finger of the user, determining, by a wearable device, a position of the wearable device on a finger of user based on a biometric parameter of the user, and activating a profile corresponding to the detected position to control a electronic device.

In an example embodiment of the present disclosure, the electronic device is controlled by detecting a movement of the finger on which the wearable device is worn, wherein the finger movement is detected using one or more sensors mounted on the wearable device to select different menu options on the electronic device.

In an example embodiment of the present disclosure, controlling the electronic device comprises at least one of, but not limited to, controlling home automation systems, operating automobile vehicles and vehicle accessories, initiating vital sign monitoring of the user, selecting one or more payment medium such as credit cards for initiating a payment, sharing the user defined profiles corresponding to each position with one or more users of the wearable device, sending an alert for personal missing elements through device to device interaction, and the like.

According to another example embodiment of the present disclosure, a wearable device comprising one or more sensors adapted for detecting a position of the wearable device on a finger of user based on a biometric parameter of a user finger, a processor adapted for generating or creating a plurality of user defined profiles, each profile associated with a position of the wearable device on the user finger, activating a profile corresponding to the detected position, and an interface adapted for receiving a user input on the wearable device to perform a preset action.

In an example embodiment of the present disclosure, the biometric parameter is a finger vein biometric.

The foregoing has outlined, in general, the various aspects of the invention and is to serve as an aid to better understanding the more complete detailed description which is to follow. In reference to such, there is to be a clear understanding that the present disclosure is not limited to the method or application of use described and illustrated herein. It is intended that any other advantages and objects of the present disclosure that become apparent or obvious from the detailed description or illustrations contained herein are within the scope of the present disclosure.

### BRIEF DESCRIPTION OF THE DRAWINGS

The other objects, features and advantages will occur to those skilled in the art from the following description of the preferred example embodiments and the accompanying drawings in which:

FIG. 1 is a schematic diagram illustrating vein identification and authentication technique according to an embodiment of the present disclosure.

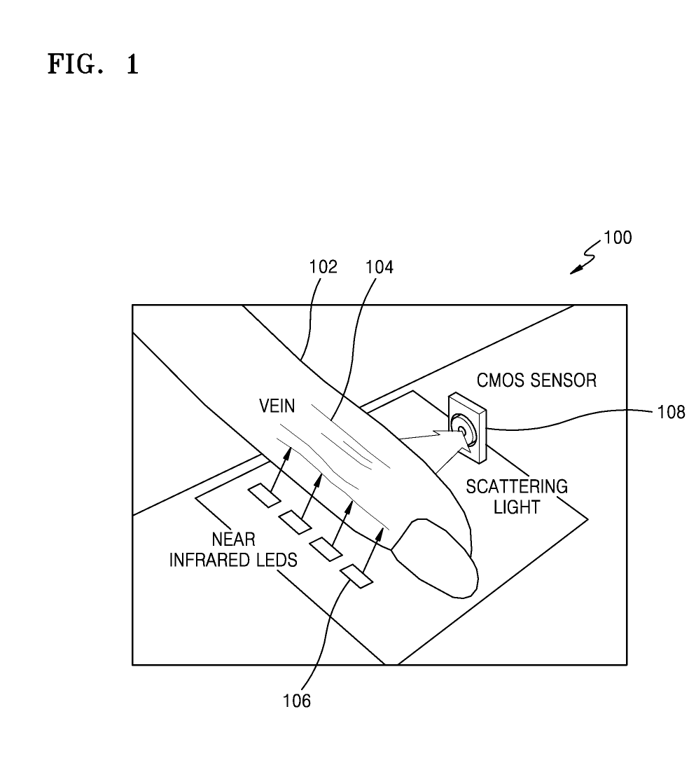

FIG. 2 is a schematic flow diagram illustrating a method of generating personalized profiles on a wearable device to control electronic devices, according to an example embodiment of the present disclosure.

FIG. 3 is a schematic diagram illustrating assignment of electronic devices to profiles of a wearable device, in which each of the profiles corresponds to a position of the wearable device on a finger of a user, according to an example embodiment of the present disclosure.

FIG. 4A is a schematic diagram illustrating a method of controlling a television (TV) using a wearable device, according to an exemplary example embodiment of the present disclosure.

FIG. 4B is a schematic diagram illustrating a method of controlling a refrigerator using a wearable device, according to another exemplary example embodiment of the present disclosure.

FIG. 5 is a schematic block diagram illustrating a wearable device, according to an example embodiment of the present disclosure.

Although specific features of the present disclosure are shown in some drawings and not in others, this is for convenience only as each feature may be combined with any or all of the other features in accordance with the present disclosure.

### DETAILED DESCRIPTION OF THE INVENTION

The present disclosure provides a wearable device and method of generating personalized profiles on the wearable device for controlling electronic devices. In the following detailed description of the example embodiments of the invention, reference is made to the accompanying drawings that form a part hereof, and in which are shown by way of illustration specific example embodiments in which the invention may be practiced. These example embodiments are described in sufficient detail to enable those skilled in the art to practice the invention, and it is to be understood that other example embodiments may be utilized and that changes may be made without departing from the scope of the present disclosure. The following detailed description is, therefore, not to be taken in a limiting sense, and the scope of the present disclosure is defined only by the appended claims.

The specification may refer to “an”, “one” or “some” example embodiment(s) in several locations. This does not necessarily imply that each such reference is to the same example embodiment(s), or that the feature only applies to a single example embodiment. Single features of different example embodiments may also be combined to provide other example embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The example embodiments of the present disclosure provide a wearable device and method of generating personalized profiles on the wearable device and controlling electronic devices. According to the present disclosure, the wearable device may be a smart ring that may control electronic devices using wireless communication techniques. According to the example embodiments of the present disclosure, the electronic devices may be any device/appliance used by a user, and the example embodiments of the present disclosure are not restricted to any particular application. The electronic devices are described in detail in the forthcoming description. The present disclosure has been described in detail with various use cases and example embodiments. The person having ordinarily skill in the art can understand that the use cases and example embodiments described in the present description are for understanding the invention and do not limit the scope of the same.

According to the present disclosure, a method of generating profiles on a wearable device and controlling electronic devices based on the profiles is described herein. The method comprises step of the wearable device detects a position of the wearable device on a finger of user based on a biometric parameter of a user finger. The user may wear the wearable device on any of his fingers. The wearable device includes one or more sensors that can detect a biometric parameter of the user and determine the position of the wearable device on a finger of user based on the biometric parameter.

In an example embodiment of the present disclosure, the biometric parameter may be a finger vein biometric determined based on vein identification and authentication systems. The vein identification and authentication systems are briefly described in the background and hence not described herein again to avoid repetition. In another example embodiment of the present disclosure, the biometric parameter for detecting the position of the wearable device on the user's fingers can be any biometric parameter associated with a biometric authentication technique, without departing from the scope of the invention.

In an example embodiment of the present disclosure, a user profile can be generated for using or accessing features of the wearable device, and vein patterns related to the user can be stored with the user profile for identifying and authenticating the user whenever the user wishes to use or access features of the wearable device.

Further, the method includes generating, by the wearable device, a plurality of profiles, each profile being associated with a position of the wearable device on a finger of the user. According to the present disclosure, profiles can be generated and assigned for each portion or region of the user's fingers, and each profile may be activated based the position of the wearable device on the finger of the user (e.g., which of the user's fingers the wearable device is worn, and further, which portion or region of the user's finger the wearable device is worn). The method includes detecting and/or measuring, by the wearable device, a biometric parameter of the finger of the user, and determining, by the wearable device, the position of the wearable device on the finger of the user based on the biometric parameter. The biometric parameter may be, for example, a user's finger vein pattern.

In an example embodiment of the present disclosure, the wearable device may include a storage unit that can store the profiles generated and assigned to each of the regions of the user's fingers. Each of the vein patterns associated with the particular region of the user's fingers can be mapped with a generated profile and can be stored in the storage unit. In another example embodiment of the present disclosure, the vein patterns of the user's fingers along with the associated profiles can be stored on any storage unit, such as, but not limited to, a remote server, a data base, a cloud server, and the like using any of the communication techniques such as, but not limited to, Bluetooth, Wi-Fi, near field communication (NFC) and the like. The person having ordinary skill in the art can understand that any type of the storage unit and communication method can be used for accessing the vein patterns and the profiles associated with the particular vein patterns of the user's fingers, without departing from the scope of the invention.

Further, the method includes activating, by the wearable device, a profile corresponding to the determined position. When the user wears the wearable device on one of the fingers, the position of the wearable device on the finger can be determined, and the profile corresponding to the determined position can be identified. Upon identifying the profile, the profile is activated.

It is to be remembered that, as the wearable device can include a plurality of positions and associated profiles, while the profile associated with the determined position is in an active state, the remaining profiles associated with the other portions or regions of the user's fingers remain in a deactivated state.

In an example embodiment of the present disclosure, the profile associated with the determined position can be deactivated. In an example embodiment of the present disclosure, the profiles associated with each portion or region of the user's fingers (e.g., the profiles associated with vein patterns of the user's fingers) may be, by default, in a deactivated state. In an example embodiment of the present disclosure, the wearable device may be customized according to user settings such that a profile associated with one of the portions or regions of the user's fingers may be, by default, in an activated state.

In another example embodiment of the present disclosure, profiles of the wearable device may be activated and deactivated by moving the wearable device according to a preset pattern. Each of the patterns may correspond to a profile and include a combination of mechanical movements of the wearable device.

Further, the method includes receiving a user input via the wearable device and performing a preset action corresponding to the user input. According to an activated profile, the user can perform one or more preset actions by moving the wearable device according to a pattern included among patterns stored in a database. In an example embodiment of the present disclosure, the preset action comprises at least one of, but not limited to, selecting and controlling one or more electronic devices, controlling a home automation system, controlling at least one of a vehicle and an accessory included in the vehicle, monitoring at least one vital sign of the user, selecting at least one pay card for initiating payment, sharing the profiles with at least one user of the wearable device, and transmitting an alert notification indicating a missing personal item based on device-to-device interaction between the wearable device and the personal item, and the like.

In an example embodiment of the present disclosure, the profile can include information such as, for example, the particular electronic device assigned to it, electronic device details, current device status, last activation/deactivation details, last activation/deactivation duration, and the like, but is not limited thereto. In another example embodiment of the present disclosure, when a profile corresponding to a position of the wearable device on the user's fingers is identified, a symbolic representation of the particular electronic device can be displayed on the wearable device, without departing from the scope of the disclosure.

According to the present disclosure, one or more portions or regions of the fingers can be identified and vein patterns associated with the one or more portions or regions of the fingers can be identified. For each of the identified portions or regions, and thus the identified vein patterns, a profile can be generated. Each of the generated profiles can be assigned preset movement patterns and preset actions.

When the user wears the wearable device on the particular portion or region of the finger, the wearable device can determine the particular portion or region based on the vein pattern. Upon determining the portion or region, the wearable device can activate the profile corresponding to the portion or region. The user may activate/deactivate the profile and perform the preset actions associated with the profile.

According to another example embodiment of the present disclosure, a method of controlling electronic devices is described herein. The method includes generating, by a wearable device, a plurality of profiles, each of the profiles being associated with a position of the wearable device on a finger of a user. According to the present disclosure, profiles can be generated and assigned for each portion or region of the user's fingers, and each profile may be activated based the position of the wearable device on the finger of the user (e.g., which of the user's fingers the wearable device is worn, and further, based on which portion or region of the user's finger the wearable device is worn).

Further, the method comprises step of determining, by a wearable device, a position of the wearable device on a finger of user based on a biometric parameter of the user. When the wearable device is moved to a portion or region of the user's fingers, the position on which the wearable device is worn can be determined along with profile associated with it based on vein identification. The method of generating one or more profiles for the one or more positions of the user's fingers and determining the profile associated with the position of the finger has been described herein above in the description and hence not described again to avoid repetition.

Further, the method includes activating, by the wearable device, a profile corresponding to the determined position and controlling an electronic device using the wearable device. When the user wears the wearable device on one of the fingers, the position of the wearable device on the finger can be determined, and the profile corresponding to the determined position can be identified. Upon identifying the profile, the profile is activated. Each of the profiles can be associated with an electronic device, and upon activating a profile based on the position of the ring on the finger, the electronic device associated with the profile can be controlled.

In an example embodiment of the present disclosure, the electronic device is controlled by detecting a movement of the finger on which the wearable device is being worn, and the finger movement is detected using one or more sensors mounted on the wearable device, and different menu options on the electronic device may be selected via the finger movement.

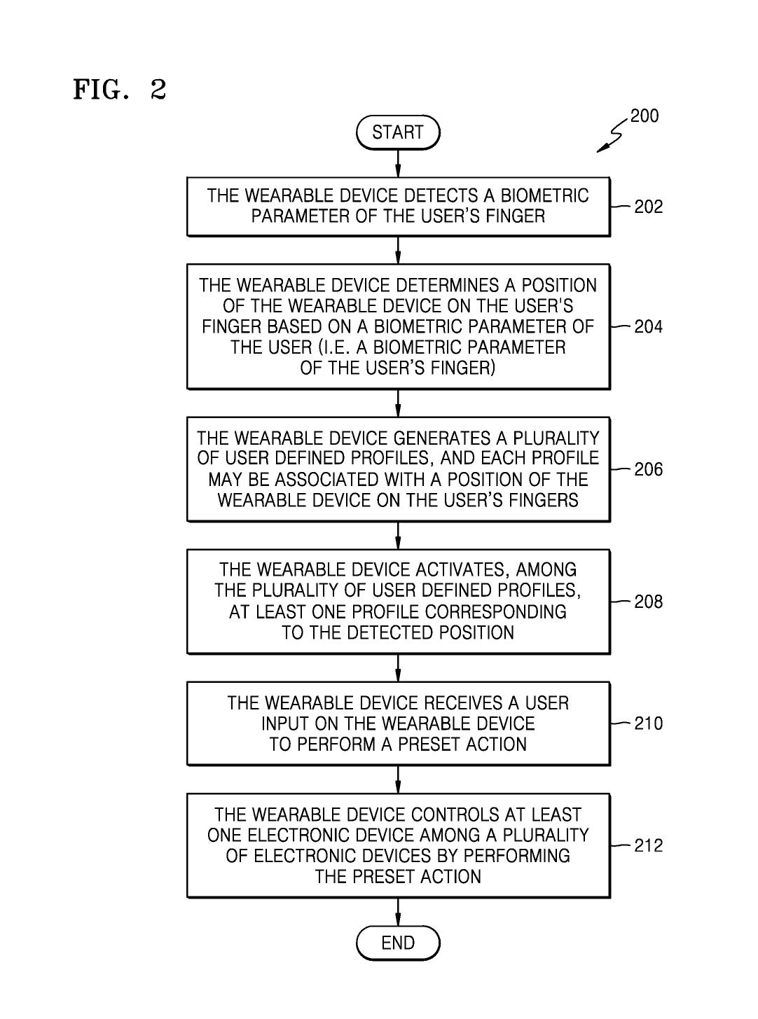

FIG. 2 is a schematic flow diagram 200 illustrating a method of generating personalized profiles on a wearable device to control electronic devices, according to an embodiment of the present disclosure. According to the flow diagram 200, at step 202, the wearable device detects a biometric parameter of the user. Generally, the wearable device may detect a biometric parameter of a finger of the user. At step 204, the wearable device determines a position of the wearable device on a finger of user based on a biometric parameter of the user's finger. Further, at step 206, the wearable device generates a plurality of user defined profiles, and each profile may be associated with a position of the wearable device on the user's fingers.

Further, at step 208, the wearable device activates, among the plurality of user defined profiles, at least one profile corresponding to the detected position. Further, at step 210, the wearable device receives a user input on the wearable device to perform a preset action. Further, at step 212, the wearable device may control at least one electronic device among a plurality of electronic devices by performing the preset action. The preset action may include, but is not limited to, selecting and controlling one or more electronic devices, controlling home automation systems, operating automobile vehicles and vehicle accessories, monitoring vital signs of the user, selecting one or more payment medium (i.e. a credit card, an NFC payment medium) for initiating a mode of payment, sharing the user defined profiles corresponding to each position with one or more users of the wearable device, transmitting an alert (notification) indicating a missing personal item based on device-to-device interaction between the wearable device and the personal item, and the like.

According an example embodiment of the present disclosure, as the wearable device may include more than one profile, whenever the user moves the ring from an initial position to a new position on a finger of the user (e.g., from the tip of the index finger of a user to the base of the ring finger of the user, or from the tip of the index finger of the user to the tip of the middle finger of the user), the wearable device may deactivate the profile associated with the initial position, identify the new position, activate a profile associated with the new position, and communicate with an electronic device associated with the activated profile. In an example embodiment of the present disclosure, one or more colors can be assigned to each of the profiles such that whenever user wears the wearable device, based on the identified position, the wearable device may activate a profile corresponding to the identified position and display the one or more colors assigned to the profile.

In another example embodiment of the present disclosure, different patterns or actions for each profile can be assigned so that whenever the user wishes to access a particular electronic device via a profile, the user can activate the profile corresponding to the electronic device by moving the wearable device according to a pattern or performing an action with the wearable device. For example, a pattern or action may include rotating the wearable device clockwise or counterclockwise or tapping the wearable device two consecutive times on a hard surface. Therefore, with respect to the example embodiment above in which a profile associated with one of the portions or regions of the user's fingers may be, by default, in an activated state, the user may access electronic devices by moving the wearable device according to a pattern or by performing an action with the wearable device, regardless of whether the user is wearing the wearable device.

According to another embodiment of the present disclosure, the wearable device may detect movement of a finger of a user while the wearable device is worn on any finger of the user and control electronic devices based on the detected movement. For example, if the user bobs up and down one or more times his/her index finger wearing the wearable device including a gyro sensor and/or a tilt sensor, the user may control electronic devices by performing a predetermined action corresponding to the movement (bobbing up and down) of the index finger of the user. Alternatively, if the user twirls his/her finger wearing the wearable device including a gyro sensor counterclockwise or clockwise, the user may control electronic devices by performing a predetermined action corresponding to the twirling movement of the index finger of the user. The finger's movement may include, but not limited to, swaying left and right, bobbing up and down and twirling.

In another example embodiment, the user can activate the profile corresponding to the electronic device by moving the wearable device according to a pattern or performing an action with the wearable device, but while also wearing the wearable device. For example, the pattern or action may include rotating the wearable device clockwise or counterclockwise or tapping the wearable device two consecutive times on a hard surface as above, but in order for the user gain access to the electronic device, the user must also be wearing the wearable device at a position associated with the profile (e.g., at the base of the ring finger of the user) while moving the wearable device according to the pattern or performing the action.

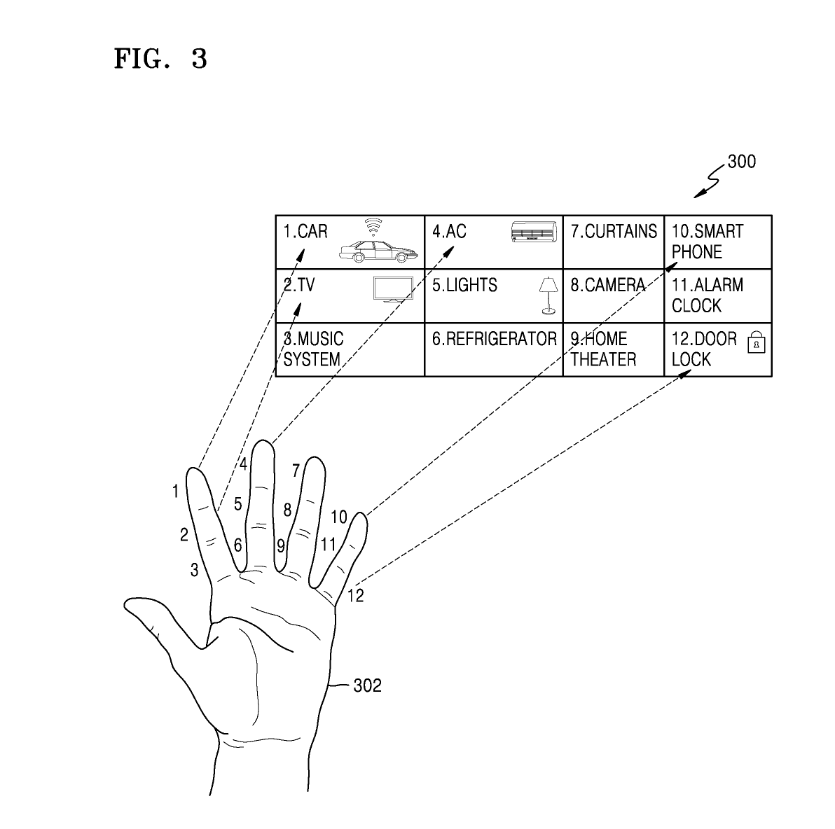

According to another embodiment of the present disclosure, an electronic device can be assigned to each of the generated profiles. FIG. 3 is a schematic diagram 300 illustrating assignment of electronic devices to profiles of a wearable device, in which each of the profiles corresponds to a position of the wearable device on a finger of a user, according to an exemplary embodiment of the present disclosure. According to the diagram 300, profiles may be generated for and assigned to regions or portions of the index, middle, ring and pinky fingers of a user's hand 302 (e.g., positions of the wearable device on the user's fingers). For example, for the user's hand 302, twelve profiles may respectively be created for twelve regions or portions (e.g., three regions on each finger, four fingers per hand). The regions or portions of the fingers of the user's hand 302 include vein patterns unique to each region or portion. The different portions of the finger may be, for example, different phalanges. Each phalange may be associated with one or more profiles. Each phalange includes of a unique set of vein patterns. Whenever the wearable device is moved into the region of a phalange, the wearable device may identify the vein pattern associated with the phalange, determine a position of the wearable device on the user's hand 302 based on the vein pattern (e.g., on which phalange the wearable device is being worn), and activate a profile corresponding to the phalange. The user may then control an electronic device corresponding to the activated profile.

Three profiles may be assigned to each of the user's fingers. For example, profiles 1, 2, and 3 may be assigned to the index finger of the user's hand 302, profiles 4, 5, and 6 may be assigned to the middle finger of the user's hand 302, profiles 7, 8, and 9 may be assigned to the ring finger of the user's hand 302, and profiles 10, 11, and 12 may be assigned to the pinky finger of the user's hand 302. The user may assign an electronic device/appliance to each of the profiles. For example, the user may assign a car to profile 1, a TV to profile 2, and a music system, an air conditioner, lights, a refrigerator, automated curtains, a camera, a home theatre, a smart phone, an alarm clock, and a door lock to profiles 3 through 12, respectively.

Whenever the user wishes to control any of the electronic devices, the user either has to directly access the electronic devices (e.g., via controls on the electronic device) or use controllers specific to the electronic devices (e.g., a key fob for a car, a remote control specific to a TV, etc.). However, with the wearable device, for each electronic device which the user wishes to control, the user may activate a profile to which the electronic device is assigned by wearing the wearable device on a region or portion of the user's fingers corresponding to the profile. Upon activation, the user can enter one or more preset patterns using the wearable device to control the electronic device (e.g., control a function of the electronic device).

In an example, the lights in a house are assigned to the profile corresponding to portion or region 5, and if the user wishes to turn off the lights without using a light switch, the user may wear the wearable device at portion or region 5. For example, the user may place the wearable device on the user's finger and wear the wearable device at portion or region 5 or, if the user is already wearing the wearable device, move the wearable device from a current position (e.g., portion or region 9) to portion or region 5. The wearable device may determine, based on the vein pattern of the user, that the wearable device is located at portion or region 5. Accordingly, the wearable device may activate the profile for portion or region 5. Once the profile is activated, the user may control the lights, for example, decrease or increase the brightness of the lights, by inputting a pattern using the wearable device. For example, the wearable device may be a smart ring, and the user may decrease or increase the brightness of the lights by rotating the ring clockwise or counterclockwise, respectively.

Various example embodiments of the present disclosure are described below.

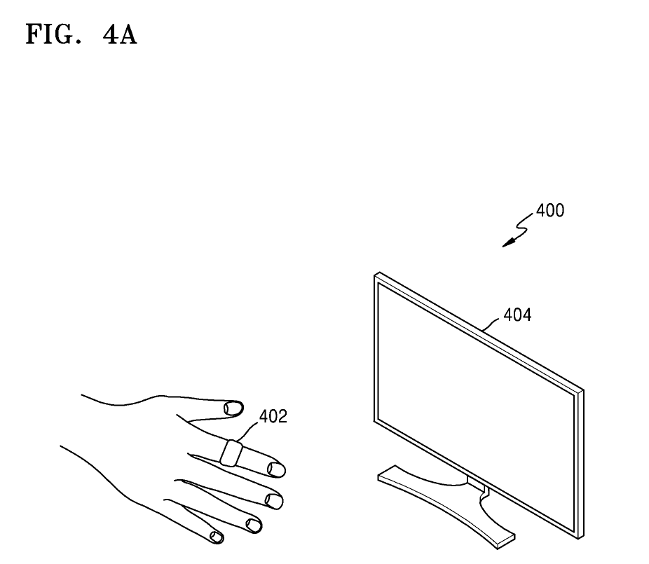

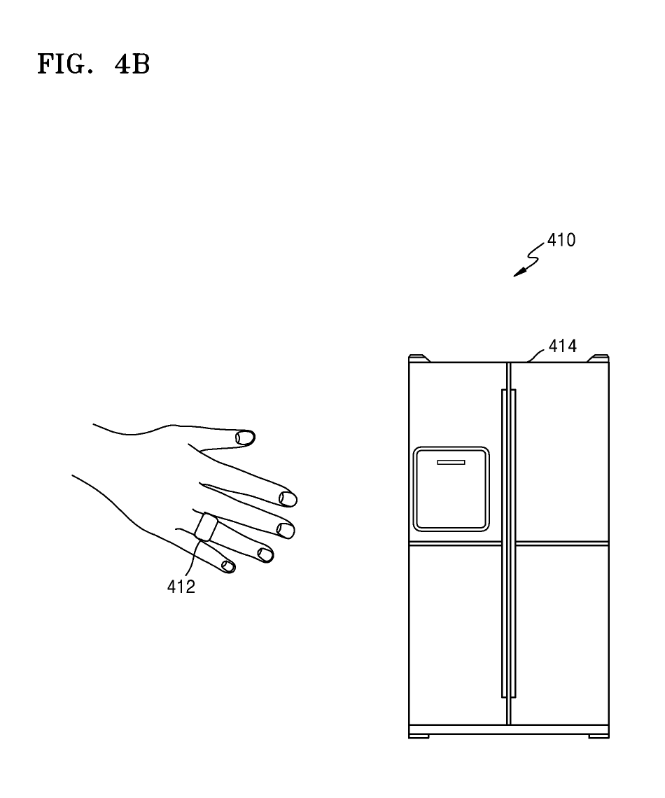

FIG. 4A is a schematic diagram 400 illustrating a use case of controlling a television (TV) 404 using a wearable device 402, according to an exemplary embodiment of the present disclosure. According to the schematic diagram 400, various electronic devices are assigned to profiles of a wearable device, in which each of the profiles corresponds to a position of the wearable device on a finger of a user.

In an example, a TV 404 is assigned to a profile corresponding to the third (base) region of the index finger of the user's hand, and if the user wishes to control the TV 404 wirelessly, without a remote control specific to the TV 404, the user may wear the wearable device 402 on the third region of the index finger of the user's hand. For example, the user may place the wearable device 402 on the user's index finger and wear the wearable device on the third region of the user's index finger or, if the user is already wearing the wearable device 402, move the wearable device 402 from a current position (e.g., third region of the user's ring finger) to the third region of the user's index finger. The wearable device 402 may determine, based on the vein pattern of the user, that the wearable device 402 is located on the third region of the user's index finger. Accordingly, the wearable device 402 may activate the profile for the third region of the user's index finger.

Once the profile is activated, the user may control the TV 404, for example, decrease or increase the volume of the TV 404, by inputting a pattern using the wearable device 402. For example, the wearable device 402 may be a smart ring, and the user may decrease or increase the volume of the TV 404 by rotating the ring clockwise or counterclockwise, respectively. Control of the TV 404 is not limited to decreasing or increasing the volume and rotating the ring. For example, the user may decrease or increase the display brightness, change the channel, select a menu option, etc., of the TV 404 by, for example, rotating the ring clockwise or counterclockwise, by tapping on a surface (e.g., knocking on a surface of a table) one or more times, by tapping two different surfaces consecutively or simultaneously, or by rotating the ring clockwise or counterclockwise with one finger (i.e. index finger of the other hand) or two fingers (i.e. thumb and index finger of the other hand).

FIG. 4B is a schematic diagram 410 illustrating a use case of controlling a refrigerator 414 using a wearable device 412, according to an example embodiment of the present disclosure. According to the schematic diagram 400, various electronic devices are assigned to profiles of a wearable device, in which each of the profiles corresponds to a position of the wearable device on a finger of a user.

In an example, a refrigerator 414 is assigned to a profile corresponding to the third region of the ring finger of the user's hand, and if the user wishes to control the refrigerator 414 wirelessly, without a remote control specific to the refrigerator 414 or without input controls located on the refrigerator 414, the user may wear the wearable device 412 on the third region of the ring finger of the user's hand. For example, the user may place the wearable device 412 on the user's ring finger and wear the wearable device on the third region of the user's ring finger or, if the user is already wearing the wearable device 412, move the wearable device 412 from a current position (e g, third region of the user's index finger) to the third region of the user's ring finger. The wearable device 412 may determine, based on the vein pattern of the user, that the wearable device 412 is located on the third region of the user's ring finger. Accordingly, the wearable device 412 may activate the profile for the third region of the user's ring finger.

Once the profile is activated, the user may control the refrigerator 414, for example, decrease or increase the internal temperature of the refrigerator 414, by inputting a pattern using the wearable device 412. For example, the wearable device 412 may be a smart ring, and the user may decrease or increase the internal temperature of the refrigerator 414 by rotating the ring clockwise or counterclockwise, respectively. Control of the refrigerator 414 is not limited to decreasing or increasing the internal temperature and rotating the ring. For example, the user may decrease or increase the internal temperature of the freezer compartment, decrease or increase the brightness of an external display located on the refrigerator, select a menu option, etc., of the refrigerator 414 by, for example, rotating the ring clockwise or counterclockwise, by tapping on a surface (e.g., knocking on a surface of a table) one or more times, by tapping two different surfaces consecutively or simultaneously, or by rotating the ring clockwise or counterclockwise with one finger (i.e. index finger of the other hand) or two fingers (i.e. thumb and index finger of the other hand).

In a similar manner, the user can control various other actions with respect to various other appliances and electronic devices, such as, but not limited to, locking and unlocking a car door, starting and stopping the engine of a vehicle, controlling a home automation system such as a sprinkler system, controlling home theatre systems, controlling automated curtains, controlling an audio system, initiating a payment via a computer application, mobile phone application, or at a point-of-sale (POS) terminal, controlling health monitoring systems, controlling a home security system, and the like. The herein abovementioned use cases, patterns and actions are merely for the understanding of the invention, and a person having ordinarily skill in the art will understand that the present disclosure can be used for various other use cases, applications, and actions, without departing from the scope of the invention.

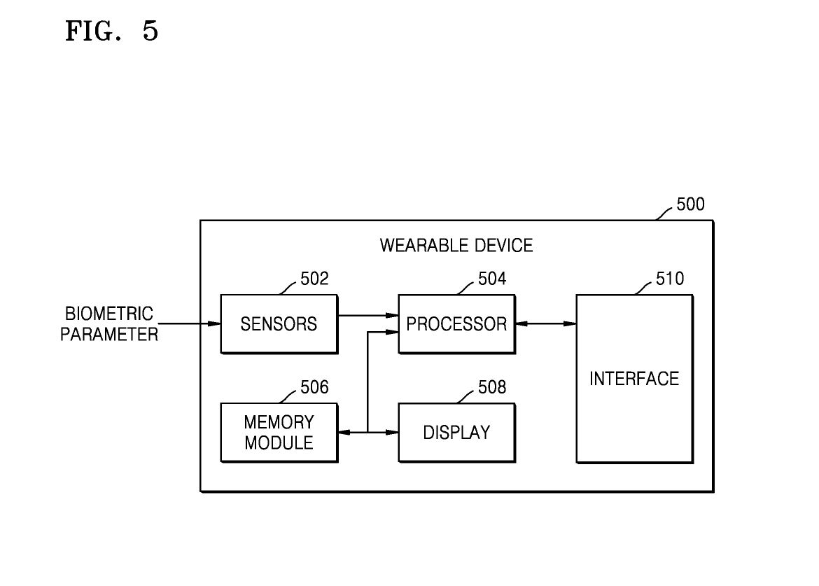

FIG. 5 is a schematic block diagram illustrating wearable device 500, according to an embodiment of the present disclosure. According to FIG. 5, the wearable device 500 may comprises one or more sensors 502, a processor 504, a storage module 506, a display 508, and an interface 510.

The wearable device may include one or more sensors 502, wherein the sensors receive signals for identifying a vein pattern of the portion of the finger on which the wearable device is worn. Further, the wearable device 500 can also include a light emitting diode (LED) source (not shown in FIG. 5), and the wearable device 500 may identify vein patterns based on light which is emitted from the LED source, passes through the veins of the finger, and is detected by the sensors. In an example embodiment of the present disclosure, the one or more sensors 502 may be CMOS sensors. The person having ordinary skill in the art can understand that any known sensor can be used for determining vein patterns of the finger, without departing from the scope of the invention.

Further, the wearable device may include a processor 504, and the processor 504 may generate profiles for one or more electronic devices that the user wishes to control. Each electronic device may be associated with a different position of the wearable device on a finger of the user. Further, the processor 504 can assign profiles customized to each user for the electronic devices, wherein movement patterns of the wearable device to perform actions with respect to the electronic devices can be assigned for the respective profiles corresponding to the electronic devices. Further, the processor 504 can activate a profile corresponding to an electronic device based on the position of the wearable device on the user's finger. The processor 504 identifies the profile based on the position of the wearable device 500 and activates the same. Further, the processor 504 can also receive user inputs via the wearable device 500, identify any pattern or patterns associated with the action, and control the electronic device based on the user inputs. For example, the wearable device 500 may perform preset actions based on the patterns.

Further, the wearable device 500 may include the storage module 506, and the storage module 506 may store vein patterns associated with different portions or regions of the fingers of the user, profiles generated for the electronic devices, and user customized versions of the profiles generated for the electronic devices. Whenever the user wears the wearable device 500, for example, on a finger of the user, the wearable device 500 detects a vein pattern and compares the detected vein pattern with vein patterns stored in a database to identify a profile corresponding to the detected vein pattern. Upon matching the captured vein pattern to a stored vein pattern, the wearable device 500 activates a profile corresponding to the detected vein pattern (e.g., activates a profile corresponding to a position of the wearable device on the finger of the user) or user customized version of the profile, along with any input patterns corresponding to the profile.

Further, the wearable device 500 may include the display 508, and the display 508 can display and show various information to the user. In an example embodiment of the present disclosure, the display 508 can display the active profile and indicate the electronic device corresponding to the active profile. In another example embodiment of the present disclosure, the display 508 can also display the action being performed and a property of the electronic device. For example, if the active profile controls the volume of the music system, the volume of the music system can be displayed on the display 508 of the wearable device 500. For example, the wearable device 500 may display the volume numerically, via bars, or the like, but is not limited thereto. In another example, the display 508 can indicate an electronic device under the control of the wearable device 500 according to an active profile, for example, via a display icon. For example, an icon representing an electronic device may be illuminated based on whether the profile corresponding to the electronic device is active or inactive, i.e., whether the electronic device is currently under the control of the wearable device 500.

Further, the wearable device 500 may include a gyro sensor and/or a tilt sensor (not shown) to detect its own movement made by a user wearing the wearable device 500. In addition, the surface of the wearable device 500 can be a touch sensitive surface so that the wearable device may detect a user's touching as a pattern input.

In another example embodiment of the present disclosure, different colors may be assigned to icons which are displayable on the display 508 of the wearable device and correspond to electronic devices controllable by the wearable device 500. In another example embodiment of the present disclosure, the wearable device may also include an audio module, and the wearable device 500 may output audio when performing an action. In an example embodiment of the present disclosure, the audio output may include, but is not limited to, ringtones, beeping sounds, alarm sounds, a recorded human voice, and the like. For example, whenever a profile corresponding to an electronic device is activated, a beep sound may be output. Whenever the electronic device is to be turned off, the wearable device 500 may output a beeping sound. In another example embodiment of the present disclosure, the one or more audio sounds can be assigned to one or more profiles associated with the electronic devices and one or more actions associated with each of the profiles.

The present example embodiments have been described with reference to specific example embodiments; it will be evident that various modifications and changes may be made to these example embodiments without departing from the broader spirit and scope of the various example embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

Although the example embodiments herein are described with various specific example embodiments, it will be obvious for a person skilled in the art to practice the invention with modifications. However, all such modifications are deemed to be within the scope of the claims. It is also to be understood that the following claims are intended to cover all generic and specific features of the example embodiments described herein and all statements of the scopes of the example embodiments which as a matter of language are interpreted as falling therebetween.

What is claimed is:

1. A method of controlling at least one device by a wearable device, the method comprising:
determining a position of the wearable device on a user's finger based on a biometric parameter of the finger;
activating a profile corresponding to the determined position of the wearable device on the user's finger; and
controlling the at least one device based on the activated profile.

2. The method of claim 1, wherein the biometric parameter of the user's finger comprises a user's finger vein pattern.

3. The method of claim 1, wherein the wearable device includes a ring device.

4. The method of claim 3, further comprising:
receiving an input of a pattern by the user,
wherein the controlling of the at least one device comprises controlling the at least one device based on the activated profile and the pattern input by the user.

5. The method of claim 4, wherein the input of the pattern comprises at least one of rotating the wearable device clockwise or counterclockwise, tapping on a surface of the wearable device one or more times, tapping two different surfaces of the wearable device consecutively or simultaneously, and rotating the wearable device clockwise or counterclockwise with one finger or at least two fingers of the user.

6. The method of claim 1, wherein the controlling of the at least one device comprises:
detecting movement of the user's finger wearing the wearable device; and
controlling the at least one device based on the detected movement.

7. The method of claim 6, the movement of the user's finger comprises at least one of swaying the finger left and right, bobbing up and down the user's finger one or more times, and twirling the user's finger one or more times.

8. The method of claim 6, wherein the wearable device comprises at least one of a gyro sensor and a tilt sensor.

9. The method of claim 1, wherein the controlling of the at least one device comprises at least one of:
controlling at least one home automation system,
controlling at least one of a vehicle, and at least one accessory included in the vehicle,
monitoring at least one vital sign of the user,
selecting at least one payment medium for initiating a payment,
sharing the plurality of profiles with at least one user of the wearable device, and
transmitting an alert notification indicating a missing personal item based on an interaction between the wearable device and the personal item.

10. The method of claim 1, wherein the profile comprises information of at least one of an electronic device assigned to the determined position, the electronic device information, a status of the wearable device, last activation information, last deactivation information, a last activation duration, and a last deactivation duration.

11. The method of claim 1, further comprising:
displaying a symbolic representation of an electronic device based on an identification of the profile corresponding to the determined position of the wearable device on the user's finger.

12. A wearable device comprising:
one or more sensors;
an interface; and
a processor configured to:
generate at least one profile corresponding to a position of the wearable device on a user's finger,
determine the position of the wearable device on the user's finger based on a biometric parameter of the user's finger detected by the one or more sensors,
activate the at least one profile, and
control an electronic device based on the at least one activated profile.

13. The wearable device of claim 12, wherein the biometric parameter of the user's finger includes a user's finger vein pattern.

14. The wearable device of claim 12,
wherein the interface is configured to receive an input of a pattern by the user, and
wherein the processor is further configured to control the electronic device based on the at least one activated profile and the pattern.

15. The wearable device of claim 12, wherein the wearable device includes a ring device.

16. The wearable device of claim 12, wherein the controlling of the electronic device comprises:
detecting movement of the user's finger wearing the wearable device; and
controlling the electronic device based on the detected movement.

17. The wearable device of claim 12, further comprising:
a display configured to display a symbolic representation of the electronic device based on an identification of the at least one profile corresponding to the determined position of the wearable device on the user's finger.

18. A method of generating a profile on a wearable device, the method comprising:
detecting a biometric parameter of a finger of a user;
determining a position of the wearable device on the finger of the user based on the biometric parameter;
generating a first profile corresponding to the determined position; and
storing the first profile.

19. The method of claim 18, further comprising:
assigning a first device among a plurality of devices to the first profile.

20. The method of claim 18, further comprising:
activating the first profile corresponding to the determined position to control the first device; and
deactivating remaining profiles other than the first profile.
